(19) United States
(12) Patent Application Publication
(10) Pub. No.: US 2011/0248836 A1
(43) Pub. Date: Oct. 13, 2011

(54) LIGHTING APPARATUS WITH ENCODED INFORMATION

(75) Inventors: George R. Brandes, Raleigh, NC (US); Julio A. Garceran, Dorham, NC (US)

(73) Assignee: CREE, INC., Durham, NC (US)

(21) Appl. No.: 12/758,007

(22) Filed: Apr. 11, 2010

(51) Int. Cl. G08B 5/00

(52) U.S. Cl. 340/332

(57) ABSTRACT

A solid state emitter or emitter package has an associated information containing element including machine readable encoded information that may be indicative of or enable retrieval of information useful for operation and/or control of at least one emitter An information containing element may be dynamically updateable, and may receive signals from at least one sensor arranged to sense a condition or characteristic of an emitter device. Operation of at least one emitter may be adjusted responsive to sensed values and predeveloped operating settings correlated to such values to mitigate degradation of output characteristics. A lighting device such as a lamp or light fixture may include an information exchange element arranged to communicate with an information containing element of an emitter or emitter package. Operation of a lighting device may depend on authentication of an emitter by a lighting.

### FIELD OF THE INVENTION

The present invention relates to lighting apparatuses, including specific embodiments directed systems and methods utilizing light emitting diodes (LEDs).

### DESCRIPTION OF THE RELATED ART

Light emitting diodes (LEDs) are solid state devices that convert electric energy to light, and generally include one or more active layers of semiconductor material sandwiched between oppositely doped layers. When bias is applied across doped layers, holes and electrons are injected into one or more active layers where they recombine to generate light that is emitted from the device. Laser diodes are solid state emitters that operate according to similar principles.

Solid state light sources may be utilized to provide colored (e.g., non-white) or white LED light (e.g., perceived as being white or near-white). White solid state emitters have been investigated as potential replacements for white incandescent lamps. A representative example of a white LED lamp includes a package of a blue LED chip (e.g., made of InGaN and/or GaN), coated with a phosphor (typically YAG:Ce or BOSE) that absorbs at least a portion of the blue light and re-emits yellow light, with the combined yellow and blue light. If the combined yellow and blue light is perceived as yellow or green, it can be referred to as ‘blue shifted yellow’ (“BSY”) light or ‘blue shifted green’ (“BSG”) light. Addition of red spectral output from a solid state emitter or lumiphoric material (e.g., phosphor) may be used to increase the warmth of the white light. As an alternative to phosphor based white LEDs, combined emission of red, blue, and green solid state emitters and/or lumiphors may also be perceived as white or near-white in character.

Solid state emitters are current-driven devices with brightness being proportional to forward current. Control of electric current supplied to solid state emitters is necessary to maintain desirable output characteristics. If current to a solid state emitter varies, then luminous intensity and chromaticity may vary (e.g., white LEDs may shift toward blue in color) and excessive heating may result, potentially leading to shortened life or damage. Variation in operating temperature may also affect luminous intensity and chromaticity. It is desirable to operate LEDs at temperatures of 85° C. or lower, if possible.

White LEDs are conventionally powered in different ways, including: (a) a current source and ballast resistors; (b) multiple current sources; and (c) a current source (e.g., inductor-based boost converter) with multiple LEDs in series connection. Dimming is also a concern for white LED emitters, since standard TRIAC-based dimming schemes (which delay turning on energy to a bulb following every zero crossing of an AC power source) applicable to incandescent lamps are not directly applicable to LEDs. LED dimming is typically done through pulse width modulation (PWM), rather than TRIAC-based dimming. To enable white light LEDs to interface with existing TRIAC-based dimmers, a driver circuit (such as the National Semiconductor LM3445) can be used to monitor the waveform from a standard TRIAC dimmer and adjust same to supply the correct PWM duty cycle and current. A versatile solid state emitter driver may provide direct control of current, PWM dimming, over-voltage protection, and load disconnect utility (to remote LEDs from the power supply when the supply is disabled and/or during dimming operation), preferably at high efficiency over a wide range of output. A solid state emitter driver is advantageously implemented with electrical control components, preferably including at least one integrated circuit and/or processor. Electrical control components arranged to control operation of one or more solid state emitters may be integrated into a solid state light bulb, a light fixture, a luminaire, or a centralized control system operatively coupled to multiple light fixtures or luminaires. Further control circuitry may be associated with a solid state emitter driver to adjust color and/or chromaticity of one or more solid state emitters.

Output characteristics (e.g., luminous intensity, chromaticity, peak output color, color rendering index, etc.) of different solid state emitters and lighting devices (including multi-emitter packages) are subject to variation relative to one another at the time of manufacture. Given such variation, individual solid state emitters and lighting devices are typically tested following manufacture over a range of operating conditions (e.g., currents and temperatures), and then sorted or “binned” in different groups having similar output characteristics based upon results of such testing. Solid state emitters and lighting devices having similar output characteristics are then utilized together in finished products or product lines, to minimize perception of variation in emitter output characteristics within the finished products or product lines. It may be possible to at least partially compensate for variations in solid state device output characteristics by adjusting supply of current to different emitters or groups thereof. It would be desirable to enable solid state emitters or groups thereof having different output characteristics to be operated in a manner to attain the same or similar output characteristics (e.g., in or among solid state lighting devices such as light fixtures or luminaires), while minimizing the resources necessary to tailor different driver circuits for such different solid state emitters or groups thereof.

Output characteristics of solid state emitters and solid state lighting devices are also subject to change with respect to time and with respect to exposure to high temperatures. Luminous flux generally declines with age and with exposure to high temperatures. Chromaticity with respect to forward current for a solid state emitter or lighting device may also shift on a permanent basis with respect to the same parameters. If a multiplicity of solid state emitters or lighting devices are installed in a given location, substitution (or addition) of a new solid state emitter or lighting device in proximity to existing emitters or lighting devices may cause any new emitters to be noticeably brighter or different in color than surrounding devices. It may be possible to at least partially compensate for solid state device output characteristics that change with respect to time and temperature by sensing light output and responsively adjusting current to one or more emitters; however, it may be expensive, impractical, and/or unsightly to include appropriate sensors and control components to accomplish such scheme. It would be desirable to minimize variation in output characteristics of proximately located solid state emitters and lighting devices of different ages, without requiring use of sensors (e.g., light sensors) and associated feedback circuits to monitor output characteristics and control such emitters or lighting devices.

High performance solid state light emitters generate substantial heat that must be dissipated to avoid premature failure or device malfunction. Emitters (and emitter packages) used with certain solid state lighting devices (e.g., light fixtures, luminaires, etc.) and display devices may be replaceable. For manufacturers of solid state lighting devices and display devices, it would be desirable to ensure and/or regulate interoperability between such devices and replacement solid state emitters and/or solid state emitter packages intended to connect therewith. For example, the original equipment manufacturer (OEM) of a solid state lighting device or display device may wish to avoid warranty claims and/or reputational damage that might result due to operating problems or hardware failures when a light fixture or display device is connected with an replacement solid state emitter or emitter package of questionable quality sourced by a supplier of unknown repute. It may be difficult for an end user to determine the quality of a accessory device without purchasing and installing a replacement part, and learning a costly lesson. Additionally, or alternatively, a lighting or display device OEM may wish to regulate the interoperability of replacement parts (including counterfeit parts) with a lighting or display device in order to derive additional revenue by direct replacement part sales or by licensing third parties the rights to produce such replacement parts.

In consequence, the art continues to seek improvements in solid state emitter devices to address one or more of the foregoing issues.

### SUMMARY OF THE INVENTION

The present invention relates to use of an information containing element in conjunction with at least one solid state emitter, such as may be useful for operation and/or control of the at least one emitter.

In one aspect, the invention relates to a solid state emitter apparatus comprising at least one solid state emitter and an information containing element including machine readable coded information useful for operation and/or control of the at least one solid state emitter, wherein the coded information is indicative of or enables retrieval of at least one of the following items (i) to (iii): (i) emitter identification and/or authentication information, (ii) emitter operating characteristics, and (iii) emitter operating instructions and/or operating settings.

In another aspect, the invention relates to a lamp or light fixture comprising: a information exchange element adapted to obtain coded information from an information containing element associated with at least one solid state emitter operatively coupled with the lamp or light fixture; and a control element adapted to control operation of the at least one solid state emitter based on any of (i) coded information obtained from the information containing element and (ii) information retrieved from a data source using the coded information obtained from the information containing element.

In a further aspect, the invention relates to a method involving use of a solid state emitter apparatus including at least one solid state emitter, and use of an information containing element associated with the solid state emitter apparatus, the method comprising: reading, from the information containing element, machine readable coded information useful for operation and/or control of the at least one solid state emitter, wherein the coded information is indicative of or enables retrieval of at least one of the following items (i) to (iv): (i) emitter identification and/or authentication information, (ii) emitter operating characteristics, (iii) emitter operating instructions and/or operating settings, and (iv) emitter operating time and/or operating service life; and controlling the at least one solid state emitter responsive to receipt of the coded information, wherein said controlling includes utilizing the coded information and/or utilizing information retrieved from a data repository using the coded information.

A further aspect of the invention relates to a solid state emitter apparatus comprising: at least one solid state emitter; an information containing element including machine readable coded information useful for operation and/or control of the at least one solid state emitter; and at least one sensor adapted to sense a parameter correlative of degradation of at least one output characteristic of the at least one solid state emitter and generate at least one output signal, wherein the at least one output signal is utilized in combination with any of (i) the coded information and (ii) information retrieved using the coded information, to affect operation of the at least one solid state emitter.

A still further aspect of the invention relates to a solid state emitter apparatus comprising at least one solid state emitter and machine readable coded information that is indicative of or enables retrieval of at least one of (a) cumulative operating time of the at least one solid state emitter; (b) cumulative power consumption of the at least one solid state emitter; (c) remaining service life of the at least one solid state emitter; and (d) remaining warranty period of the at least one solid state emitter.

Another aspect of the invention relates to a method comprising: testing at least one solid state emitter or emitter package to sense at least one output characteristic of at least one solid state emitter or emitter package; encoding information representative of or derived from a result of said testing in or on an information containing element associated with at least one solid state emitter or emitter package.

Still another aspect of the invention relates to a computer program product embodied on a computer-readable medium for use with a processor arranged to control at least one solid state emitter apparatus, wherein the computer program product is operative to: receive coded information associated with at least one solid state emitter indicative of or enabling retrieval of at least one of the following items (i) to (iv): (i) emitter identification and/or authentication information, (ii) emitter operating characteristics, (iii) emitter operating instructions and/or operating settings, and (iv) emitter operating time and/or operating service life; and control the at least one solid state emitter responsive to receipt of the coded information, wherein said control includes utilizing the coded information and/or utilizing information retrieved from a data repository using the coded information.

In another aspect, any one or more features of the foregoing aspects may be combined for additional advantage.

Other aspects, features and embodiments of the invention will be more fully apparent from the ensuing disclosure and appended claims.

### BRIEF DESCRIPTION OF THE DRAWINGS

FIG. 1 is a cross-sectional view of a solid state light emitting device including a single emitter diode and an information containing element according to one embodiment of the present invention.

FIG. 2 is a schematic top plan view of a solid state light emitting device including multiple emitter diodes, at least one information containing element, and a controller according to another embodiment.

FIG. 3 is an upper perspective view of a solid state light emitting device including four solid state emitter diodes arranged in a unitary package according to another embodiment.

FIG. 4A is an upper perspective view of a solid state light emitting device package substantially similar to the package of FIG. 3, with a lens covering the multiple emitter diodes according to another embodiment.

FIG. 4B is an upper perspective view of a portion of the emitter device package of FIG. 4A, showing the package without the lens to expose the emitter diodes and associated structures.

FIG. 4C is a top plan view of the emitter device package portion of FIG. 4B.

FIG. 4D is a bottom plan view of the emitter device package of FIGS. 4A-4C.

FIG. 5 is a simplified top view of a portion of a multi-emitter solid state lighting device package, including three emitter diodes and a conductive path independent of the emitters including at least one information containing element according to another embodiment.

FIG. 6 is a simplified top view of a portion of a multi-emitter solid state lighting device package, and an associated information containing element connectable via conductive leads to the package according to another embodiment.

FIG. 7 is a simplified top view of a portion of a multi-emitter device package, and multiple associated information containing elements connectable via conductive leads to the package according to another embodiment.

FIG. 8 is a schematic showing a lighting device such as a lamp or light fixture having an associated information exchange element operatively coupled with at least one emitter or emitter package having an associated information containing element according to another embodiment.

FIG. 9 is a schematic showing various elements of a solid state emitter testing and encoding system according to another embodiment.

FIG. 10 is a schematic showing various elements of a lighting system including multiple solid state lighting devices each including multiple emitters according to another embodiment.

FIG. 11 is a functional block diagram for an authentication scheme that may be utilized by and between a lighting apparatus or fixture and a lighting device including an associated information containing element according to another embodiment.

### DETAILED DESCRIPTION OF THE INVENTION, AND PREFERRED EMBODIMENTS THEREOF

Various embodiments of the present invention relate to use of an information containing (e.g., storage) element in conjunction with at least one solid state emitter, such as may be useful for operation and/or control of the at least one emitter.

The present invention will be described more fully hereinafter with reference to the accompanying drawings, in which embodiments of the invention are shown. The present invention may, however, be embodied in many different forms and should not be construed as limited to the specific embodiments set forth herein. Rather, these embodiments are provided to convey the scope of the invention to those skilled in the art. In the drawings, the size and relative sizes of layers and regions may be exaggerated for clarity.

Unless otherwise defined, terms (including technical and scientific terms) used herein should be construed to have the same meaning as commonly understood by one of ordinary skill in the art to which this invention belongs. It will be further understood that terms used herein should be interpreted as having a meaning that is consistent with their meaning in the context of this specification and the relevant art, and should not be interpreted in an idealized or overly formal sense unless expressly so defined herein.

As used herein, the terms solid state light emitter or solid state light emitting device may include a light emitting diode, laser diode, organic light emitting diode, and/or other semiconductor device which includes one or more semiconductor layers, which may include silicon, silicon carbide, gallium nitride and/or other semiconductor materials, a substrate which may include sapphire, silicon, silicon carbide and/or other microelectronic substrates, and one or more contact layers which may include metal and/or other conductive materials.

Solid state light emitting devices according to embodiments of the invention may include III-V nitride (e.g., gallium nitride) based LEDs or lasers fabricated on a silicon carbide substrate or a sapphire substrate such as those devices manufactured and sold by Cree, Inc. of Durham, N.C. Such LEDs and/or lasers may be configured to operate such that light emission occurs through the substrate in a so-called “flip chip” orientation. Such LEDs and/or lasers may also be devoid of substrates (e.g., following substrate removal). In certain embodiments, a discrete array or module of solid state components or emitters includes encoded information as part of the array or module.

A solid state emitter chip and/or a solid state emitter package may have at least one associated information containing element. Information contained in such element is preferably encoded (coded) based on an appropriate coding system to minimize information representation or storage requirements. In one embodiment, information contained in an information containing element is machine readable, preferably on an automatic basis (with the term ‘machine’ in this context encompassing any apparatus subject to automated reading of information, whether or not containing moving parts—with a preferred machine including a microprocessor). Information stored or otherwise represented in the information containing element may be useful for operation and/or control of at least one emitter, or to permit retrieval of further information, such as: information that may be useful for operation and/or control of at least one emitter, emitter identification information, emitter authentication information, emitter operating characteristics, emitter operating instructions, emitter operating settings, emitter operating time thresholds, and/or emitter service life. Various types of information containing elements and contents of encoded information are contemplated. In certain embodiments, coded information is electrically encoded, and such information is retrievable from an information containing element via electrical interrogation. In certain embodiments, coded information is retrievable from an information containing element via wireless communication.

In some embodiments, information is encoded in one or many (e.g., a network of) resistors and/or diodes, whereby control elements sense stored information as one or more voltages, resistances, and/or currents, and based on such sensing information is obtained on how to control a solid state emitter, solid state emitter package, group of solid state emitters, and/or lighting device. In certain embodiments, information containing elements may be integrated in a solid state emitter device package as a storage component mounted therein, such as in the form of random access memory, read only memory, flash memory, and/or other static or dynamically updateable memory elements. Information containing elements may be embodied in or comprise any one or more of hardwired discrete components, integrated circuits (including but not limited to application specific integrated circuits), firmware, and software. Information subject to storage in one or more information containing elements associated with a solid state emitter, solid state emitter package, or solid state emitter-containing device may be readable and/or writeable (e.g., machine readable and/or writable), and further capable of storing information with respect to time (e.g., by use of an integrated or external timer). In one embodiment, a machine writeable element may be updated to include information such as remaining operating time (e.g., hours), remaining operating energy (e.g., in amp-hours), and/or updated operating parameters or settings (such as may be embodied in a lookup table including operating parameters that vary with respect to time). Drive circuitry operatively coupled to one or more solid state emitters may read (or receive) encoded information and generate control signals to drive the one or more solid state emitters as a function of such encoded information.

Types of information that may be stored or otherwise represented in an information containing element broadly relate to or permit retrieval of emitter identification information, emitter authentication information, emitter operating characteristics, emitter operating instructions, emitter operating settings, emitter operating time, emitter power consumption (e.g., amp-hours), and emitter operation (e.g., operating time) within or outside one or more threshold parameters. Specific items of information include, but are not limited to, one or more of the following: bin (e.g., two dimensional color coordinate region at certain current); manufacturing lot; type; color coordinates at or as a function of drive current; operating parameters (e.g., operating voltages, drive currents, duty cycles, modulation techniques); operating ranges; activation thresholds; shutoff thresholds; authentication information; operating lifetime; information retrieval codes. Coded information is preferably added to or represented in or on an information containing element associated with a solid state emitter or emitter package at the time of manufacture and/or following testing of the solid state emitter chip or package. In one embodiment, an information containing element is disclosed in or on a body structure of at least one solid state emitter or emitter package. Following testing of at least one solid state emitter or emitter package to sense at least one output characteristic of at least one solid state emitter or emitter package, information representative of or derived from a result of said testing (e.g., correlated to the at least one output characteristic) may be encoded in or on an information containing element associated with the solid state emitter or emitter package.

In certain embodiments, additional information may be recorded in or on an information containing element associated with a solid state emitter or emitter package, such as information relating to operating lifetime (e.g., in terms of cumulative operating hours, cumulative amp-hours, hours operating at or above one or more temperature thresholds) and/or operating environment. Such recorded information may provide an operating history relating to the solid state emitter or emitter package. If the solid state emitter or emitter package may be moved to a different location or fixture, such operating history is portable with the solid state emitter or emitter package. Operating characteristics of the solid state emitter or emitter package may be adjusted based on operating history information, such as to compensate for output color and/or intensity shifts commonly experienced by solid state emitters. In one embodiment, currents to an emitter or one or more emitters in a solid state emitter package are adjusted to provide to compensate for output color and/or intensity shifts, whether based on a predicted aging profile or based on feedback from one or more sensors (e.g., to sense light color and/or light intensity).

In certain embodiments, a solid state emitter apparatus having an associated information containing element further comprises a timer. Such timer may be embodied in discrete circuitry, embodied within a microprocessor arranged to execute a timer routine, or embodied in combinations of components such as an oscillator and a counter (e.g., an inductor-resistor-capacitor circuit set to oscillate).

In one embodiment, a solid state emitter apparatus includes an associated information containing element that includes machine readable coded information that is indicative of or enables retrieval of at least one of (a) cumulative operating time of the at least one solid state emitter; (b) cumulative power consumption of the at least one solid state emitter; (c) remaining service life of the at least one solid state emitter; and (d) remaining warranty period of the at least one solid state emitter. Such information containing element is preferably dynamically updateable. The information containing element may be associated with a solid state emitter or emitter package, such as disposed in or on a body structure thereof. In one embodiment, an information containing element is integrally formed with a solid state emitter (such as a LED component), arranged on a solid state emitter submount, or arranged on a circuit board of solid state emitter device.

In certain embodiments, information containing elements associated with solid state emitters or solid state emitter packages include information retrieval codes that enable more detailed information to be retrieved from an information storage element remote from the solid state emitter or solid state emitter package. Such a remotely located information storage element may be associated with a light fixture or luminaire, or may be retrieved from a dedicated data storage element optionally accessible via a communication network.

Information may be encoded in an information containing element by electrical and/or non-electrical methods. Non-electrical information encoding methods include utilization of colored markings, printed markings, and/or structural changes to solid state emitter chips or solid state emitter packages. Structural changes may be implemented by adding and/or subtracting material from the at least one solid state emitter or solid state emitter package. Alternatively, or additionally, various electrical information encoding methods may be used. The terms “solid state emitter package” or “emitter package” as used herein refer generally to a solid state lighting device including at least one solid state emitter chip arranged on or over a board or submount. Such package may optionally include conventional items such as encapsulant, a lens, a diffuser, etc.

In one embodiment, an electrical information encoding method includes utilization of dedicated electrical leads, utilization of component leads, or both. One or more electrically operative components may be added to or associated with a solid state emitter or solid state emitter package, with encoded information being conveyed as a function of sensed characteristics of the electrically operative components. Such encoding may be embodied in or include resistive elements, capacitive elements, inductive elements, transistors, and/or diodes. In one example, one or more resistors are placed in parallel with at least one solid state emitter or solid state emitter package, and values (e.g., resistance values) of one or more resistors are sensed to convey encoded information. The value of the resistance (or each resistance) is chosen to readily facilitate measurement, but such value(s) should be selected to develop only an insignificant or negligible leakage current. In another example, a RC circuit or LRC circuit is associated with at least one solid state emitter or solid state emitter package, and encoded information may be represented by performance of such circuit (e.g., with respect to time). One or more probes may be used to receive information from at least one electrically operative component associated with a solid state emitter or solid state emitter package, such as by utilizing electrical interrogation.

In one embodiment, an electrical information encoding method includes utilization of one or more conductive binary circuits. Such circuits may be represented by DIP switches, jumpers, blown fuses, or any combination of the foregoing. Coded information may be represented as a plurality of binary bits.

In one embodiment, an electrical information encoding method includes utilization of radio frequency identification (RFID) tags. Information stored to a RFID tag may be modulated upon receipt of a wired or wireless signal, and such modulated information may be transmitted wirelessly to an information exchange element associated with or operatively coupled with a light fixture, a luminaire, or external controller. A RFID tag may be read-only or read-write in character. An associated information exchange element may be arranged to wirelessly read information from and/or writing information to a RFID tag.

In one embodiment, an electrical information encoding method includes utilization of a memory module. Nonvolatile solid state memory is preferably used. Examples of nonvolatile memory include flash memory, EPROM, EEPROM, and ferroelectric RAM. One or more magnetic memory storage elements may also be used.

In one embodiment, an information containing element is dynamically updatable to include information received during or following operation of one or more solid state emitters or emitter packages. Such information may include cumulative operating time; time operating above, below, or within one or more temperature thresholds, electric current thresholds, and/or voltage thresholds; magnitude of departure from one or more target operating parameters (e.g., temperature departure, voltage departure, or current departure); cumulative power consumed; operating error or fault events; and diagnostic codes. A dynamically updateable information containing element preferably includes an associated memory element and may be operatively coupled to at least one sensor and a timer to permit logging of sensed values (or information representative of or derived from at least one sensor output signal) with respect to time. In one embodiment, multiple sensors are provided to sense different parameters. In one embodiment, multiple sensors are provided to sense the same parameter in different locations, or to provide redundant sensing capability. Signals from multiple sensors may be averaged or processed in any desirable manner to provide a processed output signal. In one embodiment, a lighting apparatus is devoid of any light sensor. In one embodiment, one or more sensors and an information exchange element arranged to communicate with an information containing element are integrated with a solid state emitter, emitter package, or lighting device. At least one of a timer and a memory element may be associated with a solid state emitter, emitter package, or lighting device, and/or associated with at least one control element (e.g., a controller) arranged to receive signals from a plurality of solid state emitters, emitter packages, or lighting devices.

In one embodiment, warranty periods and/or maintenance periods are determined based upon one or more sensed values that may be stored in a dynamically updateable information containing element associated with a solid state emitter, emitter package, or lighting device. In one embodiment, a user is automatically notified of proximity to or expiry of one or more warranty periods or maintenance periods, or of abnormal conditions of operation of a lighting device or system. Such notification may include automatic generation of a user-perceptible signal embodied in operation of a lighting device or lighting system (e.g., flashing operation, changing color and/or intensity of operation, emission of sounds), or by generation of a signal transmitted to the user via communication means separate from a lighting apparatus or lighting system. In one embodiment, a user is notified of a notification is indication may be embodied in a user-perceptible alarm, or an automatically generated message optionally embodying text, recorded speech, or synthesized speech, optionally transmitted to a user via a communication network. In some embodiments, poor color performance (e.g., performance outside predefined specification windows) may be detected by a photodetector or other components and automatically generate a signal indicative of the need for replacement of one or more solid state emitters or associated components (e.g., control elements).

In one embodiment, information generated by a lighting apparatus or lighting device including an information containing element is transmitted between a controller and a remotely located input-output device (optionally via an intervening communication network), such as to permit remote monitoring, remote data logging, or remote control. One or more network communication devices may be used to provide desired inputs or receive desired outputs.

In one embodiment, an information containing element associated with a solid state lighting element, lighting package, or lighting device (e.g., light fixture or lamp) has a predefined network address, such as an Internet Protocol (IP) address (e.g., a static IP address), and an information exchange element arranged to communicate with the information containing element is also arranged to communicate with a communication network. In this manner, information containing element associated with a solid state lighting element, lighting package, or lighting device may be remotely accessed, monitored, or updated via a communication device that may be remotely located.

Certain embodiments of the present invention relate to use of individual solid state chips or single solid state emitter packages. In certain embodiments, a solid state emitter package may comprise one or more solid state emitters (e.g., LED chips) mounted to a board or submount. A solid state emitter package may further include packaging elements to provide environmental and/or mechanical protection, color selection, and light focusing, as well as electrical leads, contacts or traces enabling electrical connection to an external circuit. In some embodiments, such circuitry is formed in or on a substrate supporting solid state emitters.

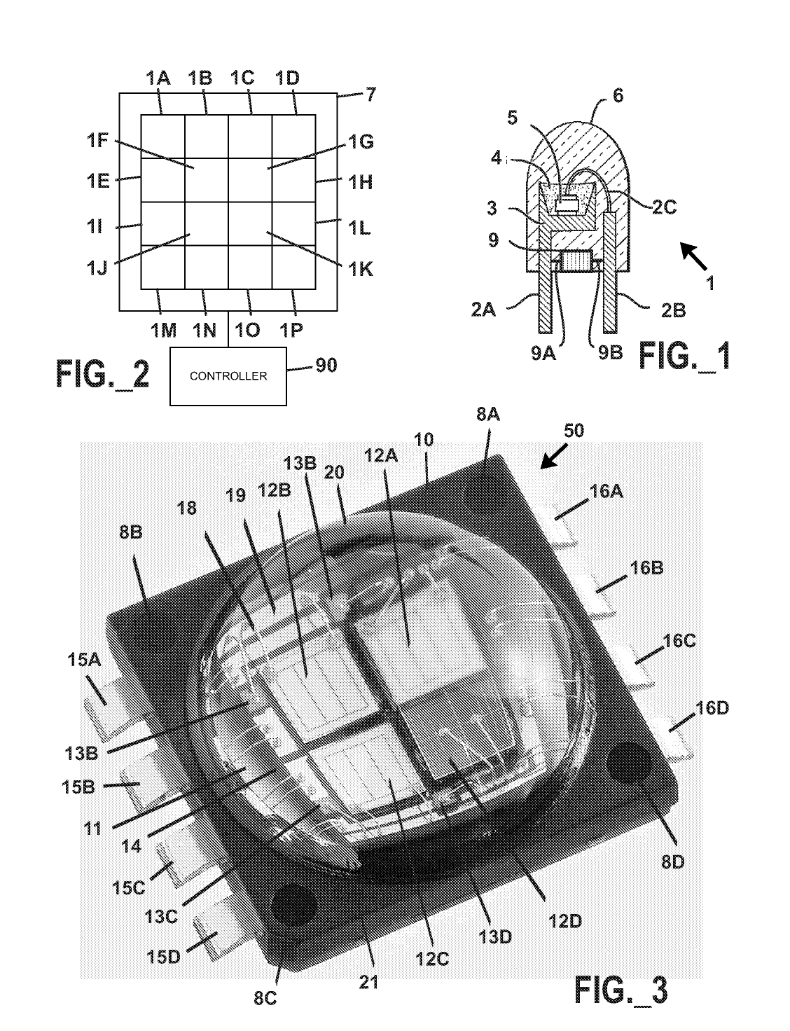

A single emitter package 1 according to one embodiment of the present invention is illustrated in FIG. 1. A LED chip 5 is mounted on a reflective cup 3 by means of a solder bond or conductive epoxy. One or more wire bonds 2C connect the ohmic contacts of the LED chip 5 to leads 2A and/or 2B, which may be attached to or integral with the reflective cup 3. The reflective cup 3 may be filled with an encapsulant material 4, which may contain a wavelength conversion material such as a phosphor. At least a portion of light emitted by the LED chip 5 at a first wavelength may be absorbed by the phosphor, which may responsively emit light at a second wavelength. The entire assembly is then encapsulated in a clear protective resin 6, which may be molded in the shape of a lens to shape or direct light emitted from the LED chip 5. At least one information containing element 9 is integrated with or affixed to the emitter package 1. In one embodiment, an information containing element 9 is arranged along a lower surface of the package 1 to enable direct electrical connection thereto. In another embodiment, the information containing element 9 may be connected to one or more of the leads 2A, 2B, such as with conductors 9A, 9B. In a further embodiment, an information containing element may be affixed along an exterior surface of the package 1, or may be embedded or otherwise contained within at least a portion of the package 1.

Multiple solid state emitter packages of the type shown in FIG. 1 (or solid state emitter chips) may be arranged in a single lighting device (e.g., lamp or light fixture), such as the lighting device 7 shown in FIG. 2. Multiple solid state emitters or emitter packages 1A-1P are arranged to be controlled with at least one common controller or control element 90. In one embodiment, the controller or control element 90 is adapted to control operation of the at least one solid state emitter based on any of (i) information obtained (e.g., read) from the information containing element 9 and (ii) information retrieved from another data source using the information obtained from the information storage element 9. In one embodiment, the controller or control element 90 may automatically query the information containing element or another data source, such as according to a predetermined schedule, upon detection of a change in configuration or operation, responsive to a sensor, or any other suitable event, with the query serving to receive information from or exchange information with the information containing element. In another embodiment, a query may be initiated with an external prompt, such a manual query initiated by a user or responsive to receipt of communication from an external device, system, or network. A query may be initiated locally or by a remote source, including by a device manufacturer or contracted maintenance party or organization. The controller or control element 90 may comprise at least one of a solid state emitter driver circuit and a solid state emitter ballast circuit adapted to utilize coded information from the information containing element 9, and/or to utilize information retrieved from a data repository (distinct from the at least one solid state emitter) using the coded information, for at least one of operation and control of the solid state emitters 1A-1P. The emitters 1A-1P may be of the same or different colors. As illustrated in FIG. 2, multiple solid state emitters 1A-1P may be disposed in a two-dimensional array. The controller 90 is arranged to receive information from an information containing element (e.g., element 9 shown in FIG. 1) associated with each emitter 1A-1P. Such information may be used by the controller 90 to operate and/or control the emitters 1A-1P, or to permit retrieval of information from an information source (not shown) such as a data repository that is separate and distinct from the emitters 1A-1P and that may be used to operate and/or control the emitters 1A-1P. The controller 90 may be optionally be operatively connected to a separate information storage device (not shown) such as a memory module to permit lookup and retrieval of information useful for control of one or more emitters, using coded information read from the information containing element as a basis for such lookup and retrieval. A memory module may be permanently associated with the lighting device 7, or intermittently connected to the lighting device (e.g., using a Universal Serial Bus connection or a network connection).

In one embodiment, the lighting device 7 (e.g., lamp or light fixture) includes an information exchange element (not shown) adapted to automatically read (or otherwise obtain) information from one or more information containing elements associated with the solid state emitters 1A-1P operatively coupled to the lighting device 7. An information exchange element may sense presence of an information containing element upon coupling of same to the lighting device 7 or upon initial operation of the lighting device 7. In one embodiment, an information exchange element reads information wirelessly from information containing elements associated with the solid state emitters 1A-1P on a sequential basis by separately transmitting a stimulation signal to each emitter 1A-1P. An information transmission stimulation signal may differ in character (e.g., with respect to voltage, current, pulse width, pulse duration, wireless character, or wired character) from a single transmitted to each emitter 1A-1P during normal operation of the lighting device 7. In one embodiment, multiple emitters 1A-1P are coupled in series during normal operation of the lighting device 7, and probes and/or other signal transmission paths, distinct from the primary series conduction path, are provided between information containing elements and the controller 90 to enable the controller 92 to discern which information read from an information containing element should be associated with a particular one or more solid state emitters 1A-1P. In one embodiment, current to each emitter 1A-1P of the lighting device 7, or to distinct groups of emitters 1A-1P of the lighting device 7, is individually controlled by the controller 90. An information containing element or an information exchange element may be attached to or embedded in a lighting device 7 distinct from any individual emitter (e.g., LED).

In certain embodiments, a multi-emitter package includes at least one information containing element. Although the preceding discussion of the lighting device 7 referred to use of individual solid state emitters 1A-1P or packages each containing single solid state emitters 1A-1P, is to be appreciated that several multi-emitter packages may be utilized in a single lighting device, such as a light fixture or luminaire. The terms “multi-emitter package” or simply “emitter package” as used herein refers generally to a light emission device including multiple solid state emitters in conjunction with at least one of a common leadframe arranged to conduct electrical power to multiple emitters, a common reflector arranged to reflect at least a portion of light emanating from multiple emitters, a common submount (or substrate) supporting the multiple emitters, and a common lens arranged to transmit at least a portion of light emanating from the plurality of solid state emitters.

Various methods may be used to tailor aggregated emissions of a solid state emitter package, light fixture, or lamp as disclosed herein according a desired end use. In one embodiment, current is independently controllable to each emitter of a plurality of solid state emitters in a solid state emitter package, light fixture, or lamp—or alternatively, to different groups of solid state emitters of different principal colors. Independent control of current to different solid state emitters of different principal colors enables a user to adjust or tune output color, as well as adjust luminous flux. In one embodiment, at least one current adjuster may be directly or switchably electrically connected to each solid state emitter or different groups of solid state emitters, to adjust current. In one embodiment, one or more solid state emitters of a plurality of emitters may be deactivated while current is supplied to other solid state emitters to provide desired luminous flux and/or output color. In one embodiment, the number and/or size of emitters of different principal colors may be adjusted to provide desired luminous flux and/or output color. In one embodiment, any one or more of the foregoing methods for tailoring aggregated emissions of a solid state emitter package, light fixture, or lamp may be combined for additional advantage.

In certain embodiments, each solid state emitter of a multi-emitter package is primarily characterized by output emissions in the visible range. Various embodiments of solid state emitter packages as disclosed herein may be devoid of any solid state emitter having peak emissions in the ultraviolet spectrum.

In certain embodiments, a solid state emitter or emitter package as disclosed herein may include at least one luminescent (also called ‘lumiphoric’) materials, such as phosphors, scintillators, lumiphoric inks) and/or filters, arranged to receive light of an input (or stimulation) wavelength range and convert such light to generate emissions (light) of a different peak wavelength or wavelength range, of any of various desired colors—including combinations of colors that may be perceived as white. Lumiphoric materials may provide up-converting or down-converting utility (i.e., outputting higher peak wavelength or lower peak wavelength spectra, respectively). Inclusion of lumiphoric materials in solid state emitter packages may be accomplished by adding such materials to encapsulants, adding such materials to lenses, or by direct coating of such materials onto one or more LEDs. Lumiphoric materials may be conformally coated on one or more individual solid state emitters. In one embodiment, a thicker coating and/or greater concentration of lumiphoric material (e.g., relative to a binder) may be applied to an individual solid state emitter or group of solid state emitters relative to another solid state emitter or group of emitters. Other materials, such as dispersers, scattering materials, and/or index matching materials, may be included in encapsulants, whether or not combined with lumiphoric materials. Various optical elements, including but not limited to collimators, may also be provided in a solid state emitter package according to embodiments of the present invention.

While solid state emitters and lumiphoric materials are recognized to have relatively narrow wavelength emission ranges (e.g., full width/half maximum wavelength spectra of less than about 20 nm in many instances), is to be understood that assignment of individual colors to such emitters and conversion materials refers to peaks or centers of output wavelengths. That is, individual emitters and lumiphoric materials typically have dominant or peak wavelengths where emissions are maximized, but an individual emitter or lumiphoric material may emit a range of other wavelengths (typically at substantially reduced intensity and efficiency) than its dominant or peak wavelength.

Emissions from a solid state emitter having an associated lumiphoric material may be fully absorbed by the lumiphor (for responsive conversion to another wavelength distribution), or only partially absorbed to enable passage of a portion of emission from the solid state emitter—such that a solid state emitter and lumiphor in combination may be adapted to emit one color peak or two color peaks (with each color peak preferably being in the visible range).

One or more lumiphoric materials (e.g., one or more first lumiphor(s) and one or more second lumiphor(s)) may be used in embodiments of the present invention. Each of the at least one first lumiphor and the at least one second lumiphor can individually comprise (or can consist essentially of, or can consist of) a phosphor. Each of the at least one lumiphor can, if desired, further comprise (or consist essentially of, or consist of) one or more highly transmissive (e.g., transparent or substantially transparent, or somewhat diffuse) binders, e.g., made of epoxy, silicone, glass, or any other suitable material. For example, if a lumiphor comprises one or more binders, then one or more phosphors can be dispersed within the one or more binders. In general, the thicker the lumiphor, then the lower the weight percentage of the phosphor may be. Depending on the overall thickness of the lumiphor, the weight percentage of the phosphor could be generally any value, e.g., from 0.1 weight percent to 100 weight percent. The lumiphor or lumiphors may be in physical contact with, or spaced apart from, one or more solid state emitters (e.g., LED(s)).

In one embodiment, a solid state emitter package includes at least one principally red solid state emitter, at least one principally blue solid state emitter, and at least one lumiphoric material (e.g., a YAG phosphor or other phosphor) adapted in combination to provide a high CRI warm white color temperature. Multiple phosphors and/or at least one supplemental solid state emitter may be added to the foregoing package for additional advantage. An information containing element associated with (or integrated with) multiple solid state emitters may include information indicative of overall color temperature or desired performance bounds for individual control of the solid state emitters.

In one embodiment, a solid state emitter package includes at least one principally red solid state emitter comprising a Portland orange solid state emitter, and at least one principally blue solid state emitter, to provide higher efficiency but lower CRI relative to the preceding (e.g., phosphor-enhanced) embodiment.

Referring now to FIG. 3, a solid state light emitter package 50 according to one embodiment of the present invention includes multiple (e.g., four) independently controllable solid state emitters 12A-12D arranged over (i.e., on or adjacent to) a common submount 14 and a common leadframe 11. While four solid state emitters 12A-12D are illustrated in FIG. 3, it is to be understood that any desirable number of solid state emitters may be embodied in a single package. The package 50 includes a molded package body 10 surrounding or at least partially encasing the leadframe 11 and a lens 20 mounted over a central region of the package 50. Although the lens 20 is shown as being substantially hemispherical in shape, other lens shapes may be used. Conductive traces 19 provided on or over the submount 14, and wirebonds 18, provide electrically conductive paths between the emitters 12A-12D and electrical leads 15A-15D and 16A-16D extending from sides of the package body 10. Double wirebonds 18 may be used as desired to facilitate even distribution of electrical current and reduce heating of the wires. The leads 15A-15D, 16A-16D may be arranged such that leads of opposite polarity type (e.g. anodes or cathodes) are provided on opposite sides of the package body 10, which may facilitate the connection of packages using such leadframes in series. A peripheral reflector 21 may be provided below the lens 20. Any of various optional features, such as mixers, diffusers, etc., may be provided in addition to or instead of the lens 20.

Registration features or molding depressions 8A-8D may be provided adjacent to corners of the in the package body 10. Attributes of these features 8A-8D or portions thereof may be modified to represent coded elements, such as by modifying shape, size, depth, color, and/or other physical attributes of each feature 8A-8D to represent coded information. A portion of any one or more of the features 8A-8D may optionally be raised. Presence or absence of any one or more of the features 8A-8D may also be representative of coded information. In one embodiment, one or more attributes of at least one portion of each feature 8A-8D is representative of a different parameter of coded information. In one embodiment, a feature interpreting device (e.g., optical scanner or probe pins) (not shown) may be operatively coupled to a lighting device (not shown) arranged to receive one or more packages 50, and outputs signals of the feature interpreting device may be supplied to the lighting device to automatically convey coded information that is indicative of or enables retrieval of information useful for operation and/or control of the emitters 12A-12D. In another embodiment, protrusions from the component package may electrically complete select external electrical traces that are electrically probed to provide information about the component.

The package 50 includes electrical leads 15A-15D, 16A-16D. In one embodiment, any of size, shape, color, and texture may be imparted to one or more of the leads 15A-15D, 16A-16D to represent coded information. Raised features (not shown) may be added to one or more leads 15A-15D, 16A-16D as representative of coded information. Where pairs of leads 15A-15D, 16A-16D correspond to one or more specific emitters in the package, coded information represented by or on such leads 15A-15D, 16A-16D may be specific to the corresponding emitters.

Continuing to refer to FIG. 3, the package 50 may have length and width dimensions of 7.0 mm×9.0 mm, inclusive of the leads 15A-15D, 16A-16D following crimping/trimming thereof. Each emitter of the four emitters 12A-12D disposed in the unitary package may be arranged with lateral edge spacing of less than about 1.0 mm, more preferably less than about 0.5 mm, from at least one adjacent emitter. Such close lateral spacing is desirable to approximate a point source, and thereby minimize perception of discrete color sources when multiple emitters of different colors are operated simultaneously—thus promoting color mixing and shadow reduction. In one embodiment, the package 50 is configured with multiple solid state emitters of different principal colors, including at least one lumiphor-converted solid state emitter (e.g., to produce white light or light of any suitable color or dominant that may be different from, or substantially the same as, emissions of one or more of the other solid state emitters).

Presence of multiple independently controllable solid state emitters of different color provides design flexibility for applications requiring color changing with high flux from compact lighting sources. Each emitter of a multi-emitter package as disclosed herein is preferably closely spaced to provide enhanced color mixing and shadow reduction for desired application. In one embodiment, a color changing light bulb (of any suitable type, such as but not limited to R16, MR16, MR16A, and MR16B bulb type) includes at least one solid state emitter package, and preferably multiple packages, as disclosed herein.

Emitter packages as disclosed herein may be integrated with or associated with light mixing elements and/or light devices of various types. In one embodiment, spectral content of an emitter package may be shifted by the inclusion of spatially separated lumiphoric material (e.g., lumiphor films), as disclosed in U.S. Patent Application Publication No. 2007/0170447 to Negley, et al., which is incorporated by reference.

In certain embodiments, emitter packages (e.g., packages 50, 50′) as described herein may be enhanced and/or tuned using light scattering materials that are arranged in configurations that are non-uniform relative to the emitters as a group, and/or relative to individual emitters, as disclosed by U.S. Patent Application Publication No. 2008/0308825 to Chakraborty, et al. One or more scattering elements (e.g., scattering elements dispersed in encapsulant) may be arranged to interact with light that would otherwise emanate from the package at a shallow angle, while light emanating from the emitters in a direction perpendicular to the upper surface of the package body 10 may interact with a reduced concentration (e.g., low concentration or zero concentration), or different type, of scattering elements.

Individually controllable solid state emitters or groups thereof may be driven with any appropriate level of current. In one embodiment, each emitter is adapted to be driven with a current of up to at least about 700 mA. In various embodiments, currents of 350 milliamps, 700 milliamps, or more may be supplied to each emitter within a solid state emitter package. In various embodiment, a light emission package as disclosed herein and including multiple emitters of different principal colors has a total lumen output of preferably at least about 300 lumens, more preferably at least about 350 lumens, and still more preferably at least about 400 lumens. In various embodiments, a solid state emitter package as described herein has a CRI of at least about 80. In various embodiments, a solid state emitter package as described herein has an efficacy of preferably at least about 25 lumens per watt, more preferably at least about 50 lumens per watt, and still more preferably at least about 100 lumens per watt, with all of the foregoing values preferably attained at a CRI of at least about 80, more preferably at least about 85.

In one embodiment, multiple separately controllable emitters or groups of emitters are provided in an emitter package or a lighting device, and coded information specific to each separate emitter or group of emitter is included in an information containing element associated with an emitter, emitter package, and/or lighting device. In one embodiment, a multi-chip solid state emitter package includes multiple separately controllable emitters and at least one information containing element including information specific to each separately controllable emitter.

With continued reference to FIG. 3, the leadframe 11 preferably comprise a thermally conductive material (e.g., a metal), and preferably defines a heatsink that may or may not be electrically active. The submount 14 may comprise a thermally conductive but electrically insulating material (e.g., aluminum nitride, a ceramic, etc.). The submount 14 may be attached to the leadframe 11 using any conventional method, including use of a thermally conductive paste. Given the electrically insulating character of a preferred submount, traces 19 and wirebonds 18 may be provided to establish electrically conductive paths to and from the solid state emitters 12A-12D.

Electrostatic discharge protection (ESD) devices 13A-13D such as zener diodes (or, alternatively, ESD devices such as ceramic capacitors, transient voltage suppression (TVS) diodes, multilayer varistors, and/or Schottky diodes) are integral to the package 50, and arranged over the submount 14 to protect the solid state emitters 12A-12D from harmful electrostatic discharge. In the illustrated embodiment, each solid state emitter 12A-12D has an associated ESD device 13A-13D. In another embodiment (e.g. if multiple emitters 12A-12D should be connected in series), each separately addressable path or separate conductive path associated with (e.g., in and/or on) the device 50 includes an associated ESD device 13A-13D. Each ESD device 13A-13D may be surface mounted on the submount 14.

A thermally conductive heatsink (e.g., metal or other conductive slug) is preferably provided below and in thermal communication with the submount 14 (e.g. via the leadframe 11) to conduct heat away from the solid state emitters 12A-12D to a bottom side of the package 50. The heatsink is preferably electrically inactive, and may be rendered so through use of an electrically insulating submount. The heatsink may be integrally formed with the leadframe (e.g., as a portion of the leadframe of a thicker gauge or otherwise enhanced mass and/or thickness), or a heatsink may be placed proximate to the leadframe, according to any suitable manufacturing process. If a submount is provided, the heatsink is preferably longer and/or wider than the submount to enhance lateral dispersion of heat emanating from the solid state emitters.

In one embodiment, the submount 14 may be eliminated, with the emitters 12A-12B (and optional ESD devices 13A-13D) being mounted on or over a leadframe 11. The leadframe may or may not be electrically active. If desired to electrically isolate part or all of the leadframe, an electrically insulating material (e.g., thin film or selectively patterned area) may be arranged between the leadframe and the emitters, with electrical traces and/or wirebonds included to provide electrical connection to the emitters and/or ESD devices. 13A-13D. Alternatively, or additionally, an electrically insulating material may be disposed (e.g., selectively patterned) between at least a portion of the leadframe and an underlying heatsink or slug to promote electrical isolation of the heatsink or slug. In another embodiment, solid state emitters (with optional ESD devices) may be mounted on or over a heatsink or slug. The heatsink or slug may be electrically active and used as a bottom side contact for devices mounted thereon, with an electrically insulating material optionally being arranged below the heatsink or slug.

In one embodiment, the emitters 12A-12D include a principally red LED 12D, a first principally blue LED 12B lacking a phosphor (or other lumiphoric material), a principally green LED 12C, and a second principally blue LED 12A having an associated yellow (or other) phosphor—with the blue LED 12A/yellow phosphor combination arranged to emit white light. Each solid state emitter 12A-12D is independently controllable via different pairs of the leads 15A-16A, 15B-16B, 15C-16C, 15D-16D. The package 50 may therefore be operated with any one, two, three, or four LEDs 12A-12D.

Although the emitters 12A-12D have been described herewith as embodying a specific combination of solid state emitters and a lumiphor, it is to be appreciated that any desired numbers and colors of solid state emitters and lumiphors as disclosed herein may be employed.

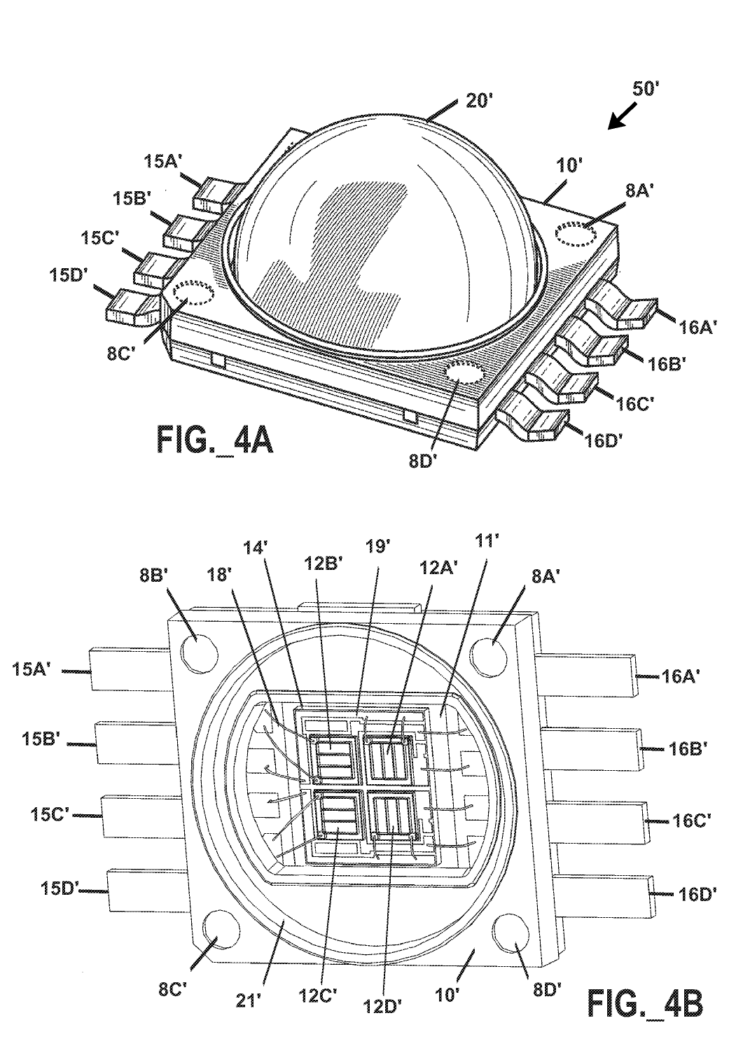

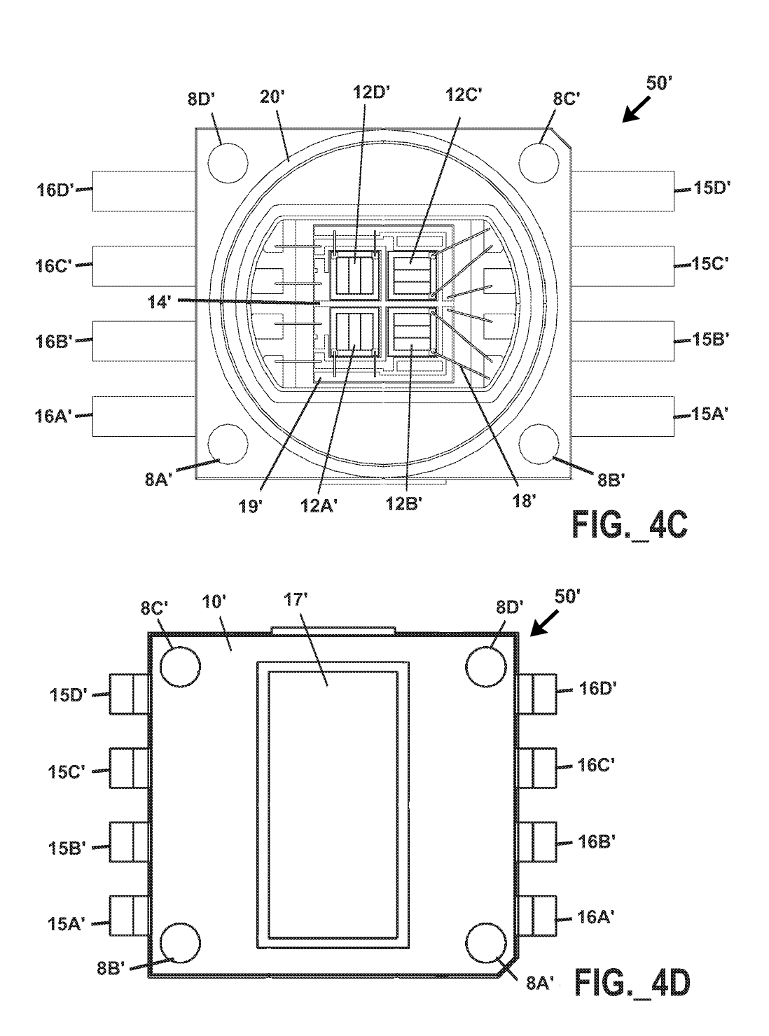

FIGS. 4A-4D depict an emitter device package 50′ substantially similar to the package 50 illustrated and described in connection with FIG. 3. The package 50′ includes four solid state emitters 12A′-12D′ arranged over a common submount 14′ and a common leadframe 11′. The package 50′ includes a molded package body 10′ surrounding the submount 14′ and a lens 20′ mounted over a central region of the package 50′. Conductive traces 19′ provided on or over the submount 14′, and wirebonds 18′, provide electrically conductive paths between the solid state emitters 12A′-12D′ and electrical leads 15A′-15D′ and 16A′-16D′ extending from sides of the package body 10′. The leads 15A′-15D′, 16A′-16D′ may be arranged such that leads of opposite polarity type (e.g. anodes or cathodes) are provided on opposite sides of the package body 10′. Registration features or molding depressions 8A′-8D′ may be formed adjacent to corners of the package body 10′. As indicated previously, one or more attributes of such features 8A′-8D′ may be modified to represent coded information. A peripheral reflector 21′ may be provided below the lens 20′. A thermally conductive heatsink or slug 17′ (optionally integrated and/or integrally formed with the leadframe 11′) is exposed along a back side of the package 50′ and is in thermal communication with the submount 14′ to conduct heat away from the solid state emitters 12A′-12D′. The heatsink or slug 17′ preferably has an exposed surface area that is larger than a facial area of the submount 14′.

Construction details for, and features of, packages including multiple solid state emitters are disclosed in the following U.S. patents and published patent applications: U.S. Patent Application Publication No. 2008/0121921 to Loh, et al.; U.S. Patent Application Publication No. 2008/0012036 to Loh, et al.; U.S. Patent Application Publication No. 2007/0253209 to Loh, et al.; and U.S. Pat. No. 7,456,499 to Loh, et al. Solid state emitter packages as described herein may be combined with any one or more features of the foregoing U.S. patent and U.S. patent application publications to Loh et al., including, but not limited to: dual thickness leadframe construction; general electrical trace patterns; and materials and methods of fabrication of various components.

In one embodiment, a solid state emitter package (e.g., packages 50, 50′) such as described above includes multiple lumiphors in addition to multiple solid state emitters. For example, with comparison to the embodiment of FIG. 3, at least two different LEDs 12A-12D may be coated with different lumiphors (e.g., phosphors). Alternatively, multiple lumiphors arranged to interact with emitters of different colors may be combined, and such combination may be coated (e.g., conformally coated) or otherwise disposed over at least two, at least three, or at least four solid state emitters 12A-12D. For example, multiple lumiphors may be combined with an encapsulant and/or coated on or integrated with a lens, with the multiple phosphors being arranged to interact with one solid state emitter, two solid state emitters, or three or more solid state emitters. Various combinations of multiple lumiphors and multiple solid state emitters are described, for example, in U.S. Patent Application Publication No. 2006/0152140 to Brandes, and U.S. Patent Application Publication No. 2007/0223219 to Medendorp, et al., which are incorporated by reference herein. By appropriate selection of LED die components and phosphor species, a close approach to the color temperature of interest can be achieved in the light output of the light emission device. Sizes (e.g., emissive area or frontal area) and/or numbers of individual emitters disposed within a multi-emitter package may be varied to at least partially compensate for performance differences among emitters of different colors, as described in U.S. Patent Application Publication No. 2006/0152140 to Brandes.

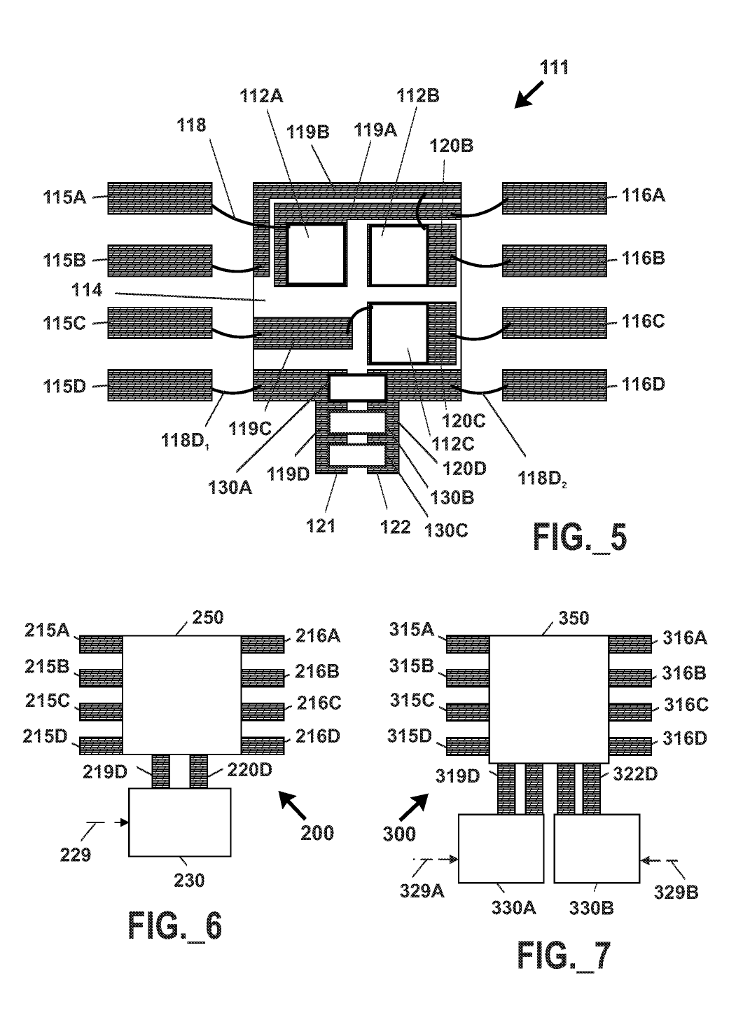

In one embodiment, a solid state emitter package includes multiple solid state emitters, mutliple leads in electrical communication with the plurality of solid state emitters, and at least two leads dedicated for interfacing with an information containing element associated with the solid state emitter package. FIG. 5 illustrates a simplified portion 111 of a multi-emitter package including three solid state emitters 112A-112C. Such layout is similar to the layout illustrated in FIG. 4B, but with the omission of a fourth emitter. Electrical leads 115A-115D and 116A-116D extend laterally outward relative to a central region of the package. A submount 114 includes electrically conductive traces or pads 119A, 119B, 120B, 119C, 120C, 119D, 120D, with the submount 114 being used to support the emitters 112A-112C. Each emitter 112A-112C has two associated wirebonds 118 to close an electrical path inclusive of the emitter 112A-112C and associated traces or pads 119A, 119B, 120B, 119C, 120C. Electrically conductive traces 119D, 120D are arranged to receive first, second, and third information containing elements 130A, 130B, 130C which are in electrical communication with contacts 115D, 116D by way of intervening wirebonds 118D₁, 118D₂. At least a portion of the laterally-extending traces 119D, 120D may be externally accessible from a package body (not shown) encasing at least some of the device portion 111. In one embodiment, at least laterally-extending portions of one or more of the traces 119D, 120D may be electrically isolated from the contacts 115D, 116D to provide more than two contacts with any of the information containing elements 130A, 130B, 130C. Any one or more desirable types of information containing elements as mentioned herein may be employed as the information containing elements 130A, 130B, 130C. Any desirable number and/or combination of leads may be used for controlling solid state emitter and/or for communicating with information containing elements 130A, 130B, 130C. In one embodiment, at one or more common leads may be used for communicating with different information containing elements 130A, 130B, 130C.

In one embodiment, a first information containing element 130A and a second information containing element 130B contain substantially the same information, but embody different types of information containing elements (e.g., ASIC, RFID tag, flash memory, conductive binary circuits, RC or LRC circuit, burned resistors, transistor arrays, etc.) to broaden compatibility of the device portion 111 with lighting devices (e.g., light fixtures or luminaires) of differing types.

In one embodiment, a first information containing element 130A is updateable to include new or additional information, and a second information containing element 130B is not updateable, such that the second information containing element 130B may provide backup or default information in case information contained on the first information containing element 130A should be corrupted or lost. Such regime provides enhances reliability.

In one embodiment, a first information containing element 130A contains information indicative of at least one of emitter identification information, emitter operating characteristics, emitter operating instructions, and emitter operating settings, and a second information containing element 130B contains authentication information arranged to facilitate an authentication exchange with a lighting device such as a light fixture or luminaire.

In certain embodiments, information containing elements may be disposed outside of and distinct from a solid state emitter or solid state emitter package body. Referring to FIG. 6, an emitter package 200 includes a package body 250 and contacts 215A-215D, 216A-216D in electrical communication with multiple emitters (not shown), and contacts 219D, 220D making electrical connections to an associated information containing element 230 disposed outside of and distinct from the package body 250. The information containing element 230 may include one or more inputs 229 to receive information (e.g., from an encoding apparatus, sensor, or the like). An input 229 may receive an input signal adapted to modify any one or more portions of the coded information, or to log new information without modifying previously encoded information. The information containing element 230 may further include one or more outputs (not shown) arranged to transmit information to a desired destination.

Multiple information containing elements 330A, 330B may be disposed outside of and distinct from a solid state emitter or solid state emitter package body. Referring to FIG. 7, an emitter package 300 includes a package body 350 and contacts 315A-315D, 316A-316D in electrical communication with multiple emitters (not shown), and contacts 319D-322D making electrical connections to two associated information containing element 330A, 330B disposed outside of and distinct from the package body 350. Each information containing element 330A, 330B may have one or more inputs 329A, 329B and/or outputs (not shown) for information exchange.

Alternative information containing elements or storage schemes may be used to store information for solid state emitter devices, such as operating information, as may be embodied in one or more predetermined standard codes. For example, information could be stored as a number, index, or pointer to a known operating scheme such as a driving configuration to use for one or more solid state emitters. Such information may be read and acted upon in accordance with a standard predefined instruction set. Additional and/or other parameters may be used for more complex control schemes.

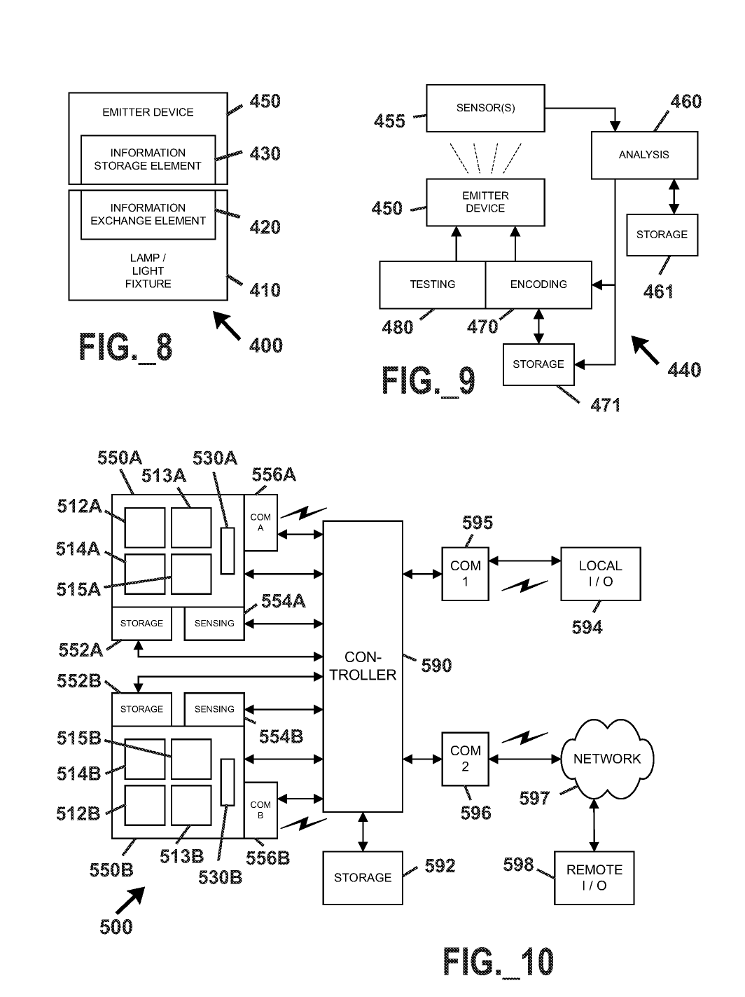

In one embodiment, a lighting device such as a lamp or light fixture includes an information exchange element adapted to exchange (e.g., read and/or write) information relative to an information containing element associated with a solid state emitter device. Referring to FIG. 8, a lighting system 400 includes a lighting device 410 such as a lamp or light fixture having an associated information exchange element 420 arranged to receive information from and/or transmit information to at least one information storage element 430 associated with at least one solid state emitter or emitter package 450. In one embodiment, multiple solid state emitters or solid state emitter packages (not shown) may be provided. In one embodiment, the information storage element 430 includes electrically encoded information that may be updated. Various information containing elements have been disclosed herein. The information exchange element 420 may be of any suitable type compatible to receive information from, and/or transmit information to, an information containing element as disclosed herein. In various embodiments, the information exchange element 420 may comprise a radio frequency antenna, an integrated circuit, a microchip, one or more electrical probes or contacts, one or more electrical circuit elements, and one or more processor interfaces. In one embodiment, the information exchange element comprises a first authentication microchip and the information storage element 430 comprises a second authentication microchip, wherein the first and second authentication microchips are arranged to communicate with one another when the at least one solid state emitter or emitter package 450 is coupled with the lighting device 410. Each of the information exchange element 420 and the information storage element 430 may be powered by the lighting device 410 upon coupling of the at least one emitter or emitter package 450 with the lighting device 410.

FIG. 9 depicts various elements of a solid state emitter testing and encoding system 440 according to one embodiment. Upon manufacture of a solid state emitter or emitter package 450, at least one emitter or emitter package 450 is operatively coupled with a testing device 480 arranged to subject the emitter(s)/emitter package 450 to various test conditions. Currents of different levels may be supplied to the emitter(s)/emitter package 450 at a given temperature, and over a range of operating temperatures. Output of the emitter(s)/emitter package 450 (e.g., intensity, color, and any other characteristics as a function of current, temperature, and any other suitable input parameters) may be sensed using one or more sensing elements 455, preferably including at least one photoelectric sensing element such as a photodiode array. Sensed information as a function of input parameters may be compared to results obtained for other emitters or emitter packages using an analysis element 460, which preferably has an associated storage element to extract information to facilitate comparison. The analysis element 460 preferably includes a microprocessor arranged to execute a pre-defined or user-defined instruction set to perform comparisons using desired criteria and appropriately categorize results thereof. Results generated by the analysis element 460 may be supplied to an encoding element 470 and stored at a storage element 471 that may be associated with the encoding element 470. The encoding element 470 (which may optionally be integrated with the testing element 480) is arranged to modify at least one aspect of the emitter device 450 and/or an information containing element associated therewith to include coded information that is derived from or representative of information obtained by the sensing and analysis steps. Any desirable information may be represented in or on an information containing element associated with a solid state emitter or emitter package including, but not limited to: bin; manufacturing lot; type; color coordinates at or as a function of drive current and/or temperature; operating parameters (e.g., operating voltages, drive currents, duty cycles, modulation techniques); operating ranges; activation thresholds; shutoff thresholds; authentication information; operating lifetime (and/or associated warranty information); and information retrieval codes to permit retrieval of other and/or more detailed information from another source of such information. After the information encoding process is complete, the emitter or emitter package 450 is removed from the testing device 480 and encoding device 470, and another emitter or emitter package is characterized and modified to include appropriate characterizing information.

In one embodiment, a lighting system may include one or more lighting devices or fixtures subject to control by a controller arranged to control the lighting devices or fixtures based upon information obtained from information containing elements associated with the lighting devices or fixtures, as well as various other inputs. Referring to FIG. 10, a lighting system 500 includes a first lighting device (e.g., lighting fixture or luminaire) 550A, at least a second lighting device 550B, a controller 590 operatively coupled with the lighting devices 550A, 550B, and a storage element 592 arranged to communicate with the controller 590. Each lighting device 550A, 550B includes multiple emitters or emitter packages (512A, 513A, 514A, 515A, and 512B, 513B, 514B, 515B, respectively), an information containing element 530A, 530B, a storage element 552A, 552B, at least one sensing element 554A, 554B, and an information exchange element 556A, 556B. The controller 590 may be arranged to exchange information with a local input/output element 594 by way of a first communication interface element 595 (whether by wired or wireless communication), and arranged to exchange information with a remote input/output element 598 by way of a second communication interface element 596 (whether by wired or wireless communication) and a network 597, such as telephone network, an intranet, or a distributed network such as the Internet. In one embodiment, the first lighting device 550A and second lighting device 550B may be arranged to communicate directly with one another.

Upon connection of the first and second lighting devices 550A, 550B with the controller 590, coded information contained in or on the information containing elements 530A, 530B is read by the information exchange elements 556A, 556B and supplied to the controller 590. Information supplied to the controller is either utilized to control the first and second lighting devices 550A, 550B, or to enable lookup and retrieval of information useable to control the first and second lighting devices 550A, 550B. Information subject to lookup and retrieval using information received from the information containing elements 530A, 530B may be stored in a storage element 592 associated with the controller and/or may be obtained via the local input/output element 594 or the remote input/output element 598. Revised operating information (e.g., updated software) may also be periodically supplied to the controller from any of the local input/output element 594 (e.g., via transfer from a memory stick or other memory device disposed proximate to the storage element 592 or controller) and the remote input/output element 598. In one embodiment, conditions of operation, sensed conditions, and/or operating history of the lighting devices 550A, 550B may be stored (e.g., using a storage element 592 operatively coupled with the controller 590) communicated to a user either locally or via the network 597, and/or communicated to a manufacturer or maintenance organization via the network 597 to validate warranty conditions, enable troubleshooting, or enable remote control operation.

In one embodiment, one or more properties of the lighting devices 530A, 530B may be sensed and logged with respect to time, and operation of the lighting devices 530A, 530B may be adjusted responsive signals indicative of the sensed values. In one example, operating time of each lighting device 530A, 530B and/or individual emitters (or emitter packages) 512A, 513A, 514A, 515A or 512B, 513B, 514B, 515B thereof may be logged. In another example, temperature and/or current of one or more portions of the lighting devices 530A, 530B (including temperature and/or current of individual emitters 512A, 513A, 514A, 515A or 512B, 513B, 514B, 515B) may be sensed using one or more temperature sensing elements. Since prolonged operation at moderately high temperature or moderately high current, and/or even short operation at very high temperature or very high current, may detrimentally affect light intensity and/or shift output color, time spent operating at elevated temperature and/or current for each lighting device 530A, 530B or individual emitters (or emitter packages) 512A, 513A, 514A, 515A or 512B, 513B, 514B, 515B thereof may be logged. Degradation in intensity and/or changes in color with respect to operating time and/or operating time at or above various threshold temperatures or currents (or other parameters) may be predicted or empirically determined (e.g., by the manufacturer of a solid state emitter or emitter package). Any parameters correlative of degradation in target output characteristics of at least one emitter, emitter package, or lighting device may be established and sensed with one or more appropriate sensors. Since variations in solid state device output characteristics may be at least partially compensated by adjusting supply of current to different emitters or groups thereof, operating settings of one or more emitters or emitter package may be developed to mitigate degradation in color and/or intensity with respect to operating time and/or time above one or more threshold parameters. Accordingly, sensed operating time and/or time spent above one or more threshold parameters may be utilized to select and apply appropriate pre-developed operating settings corresponding to the sensed operating time and/or time spent above one or more threshold parameters, in order to mitigate changes in intensity and/or color of one or more solid state emitters or emitter packages. Such changes in operating settings based on ‘aging’ of an emitter or emitter package may be in addition to any adjustments to operating settings for a given emitter or emitter package based on operating characteristics sensed upon or immediately following manufacture of such emitter or emitter package. In one embodiment, a lighting device (e.g., a lamp or light fixture) includes at least one sensing element adapted to sense a measurable parameter value of at least one of (a) a portion of the lamp or light fixture, and (b) the at least one solid state emitter, wherein the lighting device is adapted to utilize a signal indicative of the sensed parameter in combination with any of (i) coded information associated with the at least one solid state emitter and (ii) information retrieved using the coded information, to affect operation of the at least one solid state emitter.

Similar adjustments to operating settings may be used to minimize perceived variation in intensity and/or color upon replacement or addition of one solid state emitter or emitter package among or proximate to a number of ‘aged’ emitters or emitter packages previously subjected to lengthy or extreme operation. One or more aged emitters or emitter packages may be driven utilizing operating settings corresponding to the aged condition thereof (e.g., corresponding to sensed operating time and/or time spent above one or more threshold temperatures) to cause the aged emitter(s) to operate with intensity and/or color more closely approximating a new emitter. Additionally, or alternatively, one or more new or replacement emitters or emitter packages may be driven utilizing operating settings taking into account the aged condition of one or more proximately located aged emitters, whether or not the proximately located aged emitter(s) or emitter package(s) are subjected to adjusted operating conditions based on operating time and/or time spent above one or more threshold temperatures. In this manner, shifts in intensity and/or color, and differences in intensity and color among proximately located lighting devices of different ages and/or inherent output characteristics, may be avoided without use of multiple light sensors and feedback circuits, and their attendant expense, complexity, and potential unsightliness.

In one embodiment, a controller for at least one solid state emitter apparatus as disclosed herein includes a computer processor comprising at least one integrated circuit arranged to automatically execute a predefined or user-defined instruction set (e.g., computer program) embodied in a medium readable by processor circuitry (e.g., microprocessor circuitry). A computer program product for use with the foregoing processor may be operative to implement any one or more of the steps disclosed herein. In one embodiment, a computer program product is operative to receive coded information associated with at least one solid state emitter indicative of or enabling retrieval of at least one of the following items (i) to (iv): (i) emitter identification and/or authentication information, (ii) emitter operating characteristics, (iii) emitter operating instructions and/or operating settings, and (iv) emitter operating time and/or operating service life; and to control the at least one solid state emitter responsive to receipt of the coded information, wherein such control includes utilizing the coded information and/or utilizing information retrieved from a data repository using the coded information. The computer program product may be further arranged to receive at least one output signal from at least one sensor adapted to sense a parameter correlative of degradation of at least one output characteristic of the at least one solid state emitter, and to utilize the output signal in combination with coded information associated with at least one solid state emitter, and/or in combination with information retrieved using the coded information, to affect operation of the at least one solid state emitter.

One way to control interoperability between a solid state emitter or emitter package (collectively, a light emitting element) and a lighting device (e.g., a light fixture or luminaire) is through the use of authentication technology. In one embodiment, a light emitting element and a lighting device each include an authentication element, such as an integrated circuit, adapted to communicate with one another to execute an authentication scheme employed at least the first time that the light emitting element is connected to the lighting device, with successful authentication being a prerequisite for the transfer of at least certain signals or information between the light emitting element and the lighting device. In one embodiment, a challenge and response-based authentication scheme may be employed for the authentication scheme.

Examples of integrated circuits that may be used to provide or easily adapted to provide authentication functionality include: the Texas Instruments BQ26150-family of ICs (including models BQ26150DCKR and BQ26150DCKRG4) (Texas Instruments Inc., Dallas, Tex.); the Dallas Semiconductor/Maxim DS2703-family of ICs (including models DS2703U and DS2703U+)(Maxim Integrated Products, Sunnyvale, Calif.); and the Intersil ISL6296 family of ICs (Intersil Corp., Milpitas, Calif.).

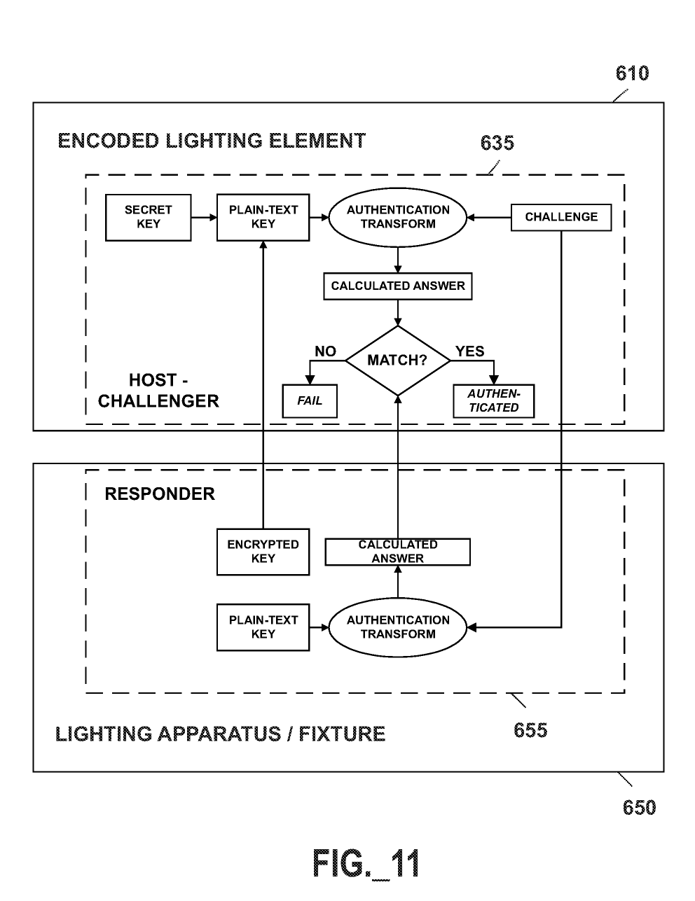

FIG. 11 provides a functional block diagram for a basic challenge and response-based authentication scheme that may be utilized by and between a light emitting element 610 and a lighting device 650. In a basic challenge and response scheme, the “host” or “challenger” (e.g., authentication element 635 associated with the light emitting element 635) sends a random challenge to the “responder” (e.g., authentication element 655 associated with the lighting device 650) upon initial connection between the two. A random challenge may consist of a number of bits of random data generated by the host. Each authentication element 635, 655 preferably includes a memory for storing certain authentication information, with the memory of at least the lighting device authentication element 455 preferably being reprogrammable. The memory of each authentication element 635, 655 preferably includes both a private memory (e.g., for including unencrypted information and/or a secret key that is preferably not subject to transmission) and a public memory (e.g., for including encrypted information and/or a public key, unique device ID, or other less sensitive information). Using stored information, the responder 655 processes the host-transmitted challenge information (e.g., by performing an authentication transform or computation, preferably utilizing the secret key or some information derived therefrom such as a public key) to produce a response string for transmission back to the host 635. On the other side, the host 635 performs the same authentication transform using stored information, or some combination of stored information and information communicated by the responder (e.g., an encrypted key passed by the responder 655). The result compares the transform value computed by the host 635 against the response (transform value) obtained from the responder 655. If the calculated data from the responder matches the answer calculated by the host, then the host authenticates the responder and allows the light emitting element and the lighting device to start operation and/or substantive communication. Otherwise, the authentication fails, and the authentication element 655 (either alone or in with the aid of one or more elements such as a controller) may fully or partially inhibit operation of the system and optionally provide a warning signal to the user.

In one embodiment, a challenge-and-response authentication scheme may utilize cyclic redundancy check (CRC) in an authentication transform. Challenges and keys of various bit lengths may be used. In one embodiment, a 32-bit random challenge and 96-bit secret ID are used in conjunction with a random polynomial and 16-bit seed value to generate a 16-bit CRC response. A unique CRC polynomial, CRC seed, and device ID value may be used in each device. Such values may be stored as encrypted text in public memory and unencrypted (plain) text in private memory, such that only a host system can decrypt the polynomial, seed, and ID values using a stored secret key. To authenticate a responder, the host reads the encrypted device ID, polynomial, and seed values from public memory, decrypts these values using a secret key, and then generates a (e.g., 32-bit) random challenge. The random challenge is transmitted to the responder, which uses challenge information from the host along with the plain-text version of polynomial coefficients, seed, and device ID to calculate the authentication CRC value. The host uses the polynomial coefficients, seed, and device ID that it decrypted, along with the random challenge that it sent to the responder to calculate the authentication CRC value. The responder authentication CRC value may be transmitted back to the host where the two authentication CRC values are compared, with a match serving to authenticate the responder and initiate system operation and/or substantive communication.

In another embodiment, a challenge-and-response authentication scheme may utilize an iterative hashing algorithm such as the SHA-1/HMAC secure hash algorithm, which has been widely used for authentication of Internet transactions. The authentication method is similar to a CRC-based scheme except it utilizes a different algorithm. The host reads a (e.g., 128-bit) encrypted device ID from the public memory and decrypts those values using the secret key to yield plain-text information with root keys. Then it generates a (e.g., 160-bit) random challenge that is transmitted to the responder, which uses the plain-text version of the ID along with the random challenge to calculate an authentication digest value. The host uses the decrypted ID and the same random challenge to calculate its own authentication digest value. When both digest values have been calculated, the host reads the authentication digest value from the responder and compares that value to its own authentication digest value. If a match is obtained, then the responder is authenticated and system operation and/or substantive communication may be initiated.

In one embodiment, an authentication element employs the Secure Hash Algorithm (SHA-1) specified in the Federal Information publication 180-1 and 180-2, and ISO/IEC 10118-3. An authentication IC embedded in the accessory device processes a host transmitted challenge using a stored secret key and unique ROM ID to produce a response word for transmission back to the host. The secret key is securely stored on-chip and never transmitted between the battery and the host. If each of the secret key and the ROM ID includes 64 bits, the response may include 160 bits.

In another embodiment, an authentication operation may involve multiple iterative steps to “unlock” various features or functions of a light emitting element or lighting device, such that multiple discrete tiers of functionality of the light emitting element or lighting device may be enabled or disabled depending on the result of an authentication operation between the two. In other words, following an authentication operation, operation of a light emitting element with a lighting device may commence, but in a limited or restricted fashion, or in an unrestricted fashion, depending on the result of the authentication operation. Different levels or tiers of operation that may be unlocked, whether individually in combination, depending on the result of an authentication operation include (but are not limited to) the following examples:
enabling operation at full rated current/intensity versus operation at restricted current/intensity;
enabling operation at a full range of potential color(s) versus a restricted range of potential color(s);
enabling operation with settings to attain maximum color rendering index versus settings only attaining reduced color rendering index;
enabling full range of dimming operation (e.g., enabling small controllable steps in intensity to a rated minimum output) versus partial dimming operation (e.g., enabling dimming only via large controllable steps to a minimum output above a rated minimum output), or disallowing dimming operation altogether;
shut off or adjust operation based on operating time or failure to authenticate (e.g., if an unlicensed solid state emitter product, control component, or sensing component is attempted to be used);
enabling adjustment of operating settings among proximate emitters to mitigate differences in perceived intensity and/or color, versus disallowing such adjustment; and
enabling remote troubleshooting, remote control, and/or data logging capabilities, versus disallowing one or more of such utilities.

Thus, authentication elements and authentication methods as disclosed herein permit not only “yes/no” threshold operability between a light emitting element and a lighting device (e.g., a light fixture or luminaire, optionally associated with a central controller), but also permit discrete functions of a lighting device or lighting system to be enabled or disabled depending on the result of an authentication operation.

While the preceding description has focused primarily on solid state emitters, it is to be appreciated that various principles and features as disclosed herein may be applied to light emitters and lighting systems of other or mixed types, including but not limited to: incandescent emitters, halogen emitters; high intensity discharge emitters, and fluorescent emitters. Additionally, while the invention has been described with particular reference to certain processors, memory, computer programs, and other discrete components, it is to be understood that embodiments or portions thereof may be implemented using different arrangements of components, and further using applicant specific integrated circuits, software driven processor circuitry, firmware, programmable logic devices, and various storage and retrieval elements.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Any of various elements or features recited herein is contemplated for use with other features or elements disclosed herein, unless specified to the contrary. Correspondingly, the invention as hereinafter claimed is intended to be broadly construed and interpreted, as including all such variations, modifications and alternative embodiments, within its spirit and scope.

1. A solid state emitter apparatus comprising at least one solid state emitter and an information containing element including machine readable coded information useful for operation and/or control of the at least one solid state emitter, wherein the coded information is indicative of or enables retrieval of at least one of the following items (i) to (iii): (i) emitter identification and/or authentication information, (ii) emitter operating characteristics, and (iii) emitter operating instructions and/or operating settings.

2. The apparatus of claim 1, wherein the coded information is electrically encoded.

3. The apparatus of claim 2, wherein the coded information is represented as a plurality of binary bits.

4. The apparatus of claim 1, wherein the coded information is retrievable from the solid state emitter apparatus via electrical interrogation.

5. The apparatus of claim 1, wherein the coded information is retrievable from the solid state emitter apparatus via wireless communication.

6. The apparatus of claim 1, wherein the coded information enables retrieval of information stored in a data repository that is separate and distinct from the apparatus.

7. The apparatus of claim 1, wherein the at least one solid state emitter comprises a plurality of solid state emitters.

8. The apparatus of claim 7, wherein the coded information comprises information specific to each solid state emitter of the plurality of solid state emitters.

9. The apparatus of claim 1, comprising a plurality of solid state emitter modules, wherein each solid state emitter module of the plurality of solid state emitter modules comprises a plurality of solid state emitters and at least one of the following: (a) a common reflector arranged to reflect at least a portion of light emanating from the plurality of solid state emitters, (b) a common substrate supporting the plurality of solid state emitters, and (c) a common lens arranged to transmit at least a portion of light emanating from the plurality of solid state emitters.

10. The apparatus of claim 1, wherein the coded information is indicative of or enables retrieval of at least one of emitter identification and emitter authentication information.

11. The apparatus of claim 1, wherein the coded information is indicative of or enables retrieval of emitter operating characteristics.

12. The apparatus of claim 1, wherein the coded information is indicative of or enables retrieval of emitter operating instructions and/or operating settings.

13. The apparatus of claim 1, wherein the coded information is indicative of or enables retrieval of emitter operating time and/or operating service life.

14. The apparatus of claim 1, further comprising an input element allowing receipt of an input signal adapted to modify the coded information.

15. The apparatus of claim 1, further comprising at least one sensor adapted to sense a parameter correlative of degradation of at least one output characteristic of the at least one solid state emitter and generate at least one output signal, wherein the at least one output signal is utilized in combination with any of (i) the coded information and (ii) information retrieved using the coded information, to affect operation of the at least one solid state emitter.

16. A lighting device comprising the apparatus of claim 1 and an information exchange element adapted to automatically obtain the coded information from the information containing element.

17. A lamp or light fixture comprising:
an information exchange element adapted to obtain coded information from an information containing element associated with at least one solid state emitter operatively coupled with the lamp or light fixture; and
a control element adapted to control operation of the at least one solid state emitter based on any of (i) coded information obtained from the information containing element and (ii) information retrieved from a data source using the coded information obtained from the information containing element.

18. The lamp or light fixture of claim 17, wherein the information exchange element is adapted to automatically retrieve the coded information from the information containing element by electrical interrogation.

19. The lamp or light fixture of claim 17, wherein the information exchange element is adapted to automatically retrieve the coded information from the information containing element by wireless communication.

20. The lamp or light fixture of claim 17, wherein the coded information is electrically encoded.

21. The lamp or light fixture of claim 17, wherein the coded information is represented as a plurality of binary bits.

22. The lamp or light fixture of claim 17, wherein the control element comprises at least one of a ballast circuit and a driver circuit.

23. The lamp or light fixture of claim 17, further comprising at least one sensor adapted to sense a parameter correlative of degradation of at least one output characteristic of the lamp or light fixture and generate at least one output signal, wherein the lamp or light fixture is adapted to utilize the at least one output signal in combination with any of (i) the coded information and (ii) information retrieved using the coded information, to affect operation of the at least one solid state emitter.

24. The lamp or light fixture of claim 23, wherein the parameter comprises at least one of temperature, electric current, and cumulative power consumption.

25. The lamp or light fixture of claim 17, further comprising at least one communication element adapted to communicate with an other lamp or light fixture, to affect operation of at least one solid state emitter to reduce perception of difference of at least one of intensity and color output by the lamp or light fixture and the other lamp or light fixture.

26. The lamp or light fixture of claim 17, wherein the coded information is indicative of or enables retrieval of at least one of the following items (i) to (iii): (i) emitter identification and/or authentication information, (ii) emitter operating characteristics, and (iii) emitter operating instructions and/or operating settings.

27. A method involving use of a solid state emitter apparatus including at least one solid state emitter, and use of an information containing element associated with the solid state emitter apparatus, the method comprising:
reading, from the information containing element, machine readable coded information useful for operation and/or control of the at least one solid state emitter, wherein the coded information is indicative of or enables retrieval of at least one of the following items (i) to (iv): (i) emitter identification and/or authentication information, (ii) emitter operating characteristics, (iii) emitter operating instructions and/or operating settings, and (iv) emitter operating time and/or operating service life; and
controlling the at least one solid state emitter responsive to receipt of the coded information, wherein said controlling includes utilizing the coded information and/or utilizing information retrieved from a data repository using the coded information.

28. The method of claim 27, wherein the coded information is electrically encoded, and the reading involves electrically interrogating the solid state emitter apparatus.

29. The method of claim 27, wherein the at least one solid state emitter comprises a plurality of solid state emitters.

30. The method of claim 29, wherein the coded information comprises information specific to each solid state emitter of the plurality of solid state emitters.

31. The method of claim 27, further comprising receiving an input signal, and modifying coded information stored or represented in or on the solid state emitter apparatus responsive to receipt of the input signal.

32. The method of claim 27, wherein the coded information is indicative of or enables retrieval of at least one of emitter identification and emitter authentication information.

33. The method of claim 27, wherein the coded information is indicative of or enables retrieval of emitter operating characteristics.

34. The method of claim 27, wherein the coded information is indicative of or enables retrieval of emitter operating instructions and/or operating settings.

35. The method of claim 27, wherein the coded information is indicative of or enables retrieval of emitter operating time and/or operating service life.

36. A solid state emitter apparatus comprising:
at least one solid state emitter;
an information containing element including machine readable coded information useful for operation and/or control of the at least one solid state emitter; and
at least one sensor adapted to sense a parameter correlative of degradation of at least one output characteristic of the at least one solid state emitter and generate at least one output signal, wherein the at least one output signal is utilized in combination with any of (i) the coded information and (ii) information retrieved using the coded information, to affect operation of the at least one solid state emitter.

37. The apparatus of claim 36, wherein the information containing element is dynamically updateable to include information representative of or derived from the at least one output signal.

38. A solid state emitter apparatus comprising at least one solid state emitter and machine readable coded information that is indicative of or enables retrieval of at least one of (a) cumulative operating time of the at least one solid state emitter; (b) cumulative power consumption of the at least one solid state emitter; (c) remaining service life of the at least one solid state emitter; and (d) remaining warranty period of the at least one solid state emitter.

39. A method comprising:
testing at least one solid state emitter or emitter package to sense at least one output characteristic of at least one solid state emitter or emitter package;
encoding information representative of or derived from a result of said testing in or on an information containing element associated with at least one solid state emitter or emitter package.

40. The method of claim 39, wherein the information containing element is disposed in or on a body structure of the at least one solid state emitter or emitter package.

41. The method of claim 39, wherein the information representative of or derived from a result of said testing is electrically encoded in the information containing element.

42. A computer program product embodied on a computer-readable medium for use with a processor arranged to control at least one solid state emitter apparatus, wherein the computer program product is operative to:
receive coded information associated with at least one solid state emitter indicative of or enabling retrieval of at least one of the following items (i) to (iv): (i) emitter identification and/or authentication information, (ii) emitter operating characteristics, (iii) emitter operating instructions and/or operating settings, and (iv) emitter operating time and/or operating service life; and
control the at least one solid state emitter responsive to receipt of the coded information, wherein said control includes utilizing the coded information and/or utilizing information retrieved from a data repository using the coded information.

43. The apparatus of claim 1, further comprising a solid state emitter driver adapted to utilize the coded information, or information retrieved using the coded information, for at least one of operation and control of the at least one solid state emitter.
